(19) United States
(12) Patent Application Publication
(10) Pub. No.: US 2011/0202229 A1
(43) Pub. Date: Aug. 18, 2011

(54) IN-VEHICLE TIRE GAUGE SYSTEM AND METHODS

(75) Inventors: Kevin W. Owens, Sterling Heights, MI (US); Daniel C. McGarry, Oxford, MI (US); Kevin R. Krause, Plymouth, MI (US)

(73) Assignee: GENERAL MOTORS LLC, DETROIT, MI (US)

(21) Appl. No.: 12/708,096

(22) Filed: Feb. 18, 2010

(51) Int. Cl. G06F 7/00

(52) U.S. Cl. 701/33; 701/29

(57) ABSTRACT

In-vehicle tire gauge system and methods are disclosed herein. The in-vehicle tire gauge system includes a user activated system operatively positioned in a vehicle. The user activated system includes at least one of preset voice prompts or audible tones for guiding a tire pressure check routine, a monitoring system for detecting a tire filling event, and a module for converting tire pressure data into audible feedback. At least one tire pressure monitoring sensor is operatively positioned at each tire of the vehicle and is configured to collect the tire pressure data and transmit such data to the module. An audio system is in operative communication with the user activated system, and is configured to output, via in-vehicle speakers associated with the audio system, the at least one of preset voice prompts or audible tones, the audible feedback, or combinations thereof.

### TECHNICAL FIELD

The present disclosure relates generally to in-vehicle tire gauge systems and methods.

### BACKGROUND

Maintaining accurate tire pressure can improve vehicle performance in a variety of ways, including, for example, enhancing vehicle handling, extending tire life, and increasing gas mileage. Systems that make tire pressure maintenance more convenient are desirable.

### SUMMARY

In-vehicle tire gauge systems and methods are disclosed herein. An example of the in-vehicle tire gauge system includes a user activated system operatively positioned in a vehicle. The user activated system includes at least one of preset voice prompts or audible tones for guiding a tire pressure check routine, a monitoring system for detecting a tire filling event, and a module for converting tire pressure data into audible feedback. At least one tire pressure monitoring sensor is operatively positioned at each tire of the vehicle and is configured to collect the tire pressure data and transmit such data to the module. An audio system is in operative communication with the user activated system, and is configured to output, via in-vehicle speakers associated with the audio system, the at least one of preset voice prompts or audible tones, the audible feedback, or combinations thereof.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram of an example of an in-vehicle tire gauge system;

FIG. 2 is a schematic diagram of another example of a system including an example of the in-vehicle tire gauge system in a vehicle that is in selective communication with a telematics service center;

FIG. 3 is a flow diagram depicting various examples of an in-vehicle tire gauge system; and

FIG. 4 is a flow diagram of another example of the in-vehicle tire gauge system.

### DETAILED DESCRIPTION

Examples of the method and system disclosed herein advantageously enable a vehicle operator to utilize the in-vehicle systems as a tire pressure gauge. As such, a mechanical gauge is not needed. Furthermore, the in-vehicle system utilizes a user activated system which transmits audio prompts to the user during the tire pressure check routine. This advantageously allows the system to be used in any vehicle, whether or not that vehicle is equipped with PSI display capabilities. This also advantageously allows the user to follow the prompts of the tire pressure check routine without having to re-enter the vehicle to check the then-current PSI. As such, the method and system disclosed herein substantially simplify tire maintenance.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

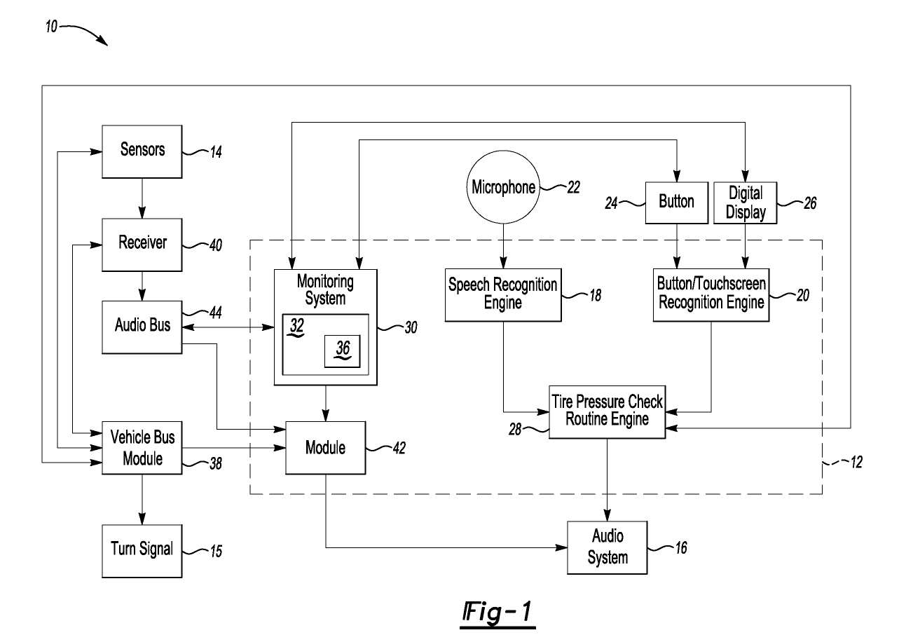

Referring now to FIG. 1, an example of the in-vehicle tire gauge system 10 is depicted. Generally, the system 10 includes a user activated system 12, tire pressure sensors 14, and an audio system 16. As described further herein, these components 12, 14, and 16 work together with other in-vehicle components to run a tire pressure check routine.

The user activated system 12 includes a voice activated or speech recognition engine 18 and/or a button/touchscreen press recognition engine 20. The speech recognition engine 18 is operatively connected to a microphone 22, which converts acoustical pressure waves (sound (i.e., the user's utterance)) into electrical signals and transmits them to the speech recognition engine 18. The speech recognition engine 18 is configured, in some instances, to record the utterances, and to run one or more software programs and/or software routines having computer readable code for recognizing and responding to a user's spoken command. Similarly, the button/touchscreen press recognition engine 20 is operatively connected to in-vehicle buttons, knobs, switches, keyboards, and/or controls 24 and, when present, an in-vehicle display 26. The display 26 may be operatively connected to the telematics unit 32 directly, or may be part of the audio system 16. Non-limiting examples of the display 26 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like. When the control(s) 24 is/are operated or a command is entered via the display 26, the button/touchscreen press recognition engine 20 is configured to transmit such command to another component (e.g., a tire pressure check routine engine 28) which runs one or more software programs and/or software routines having computer readable code for recognizing and responding to a user's input. While not shown in FIG. 1, it is to be understood that a user's input may also be entered via an auxiliary device in operative communication with the vehicle (e.g., via a USB connection or a short-range wireless connection).

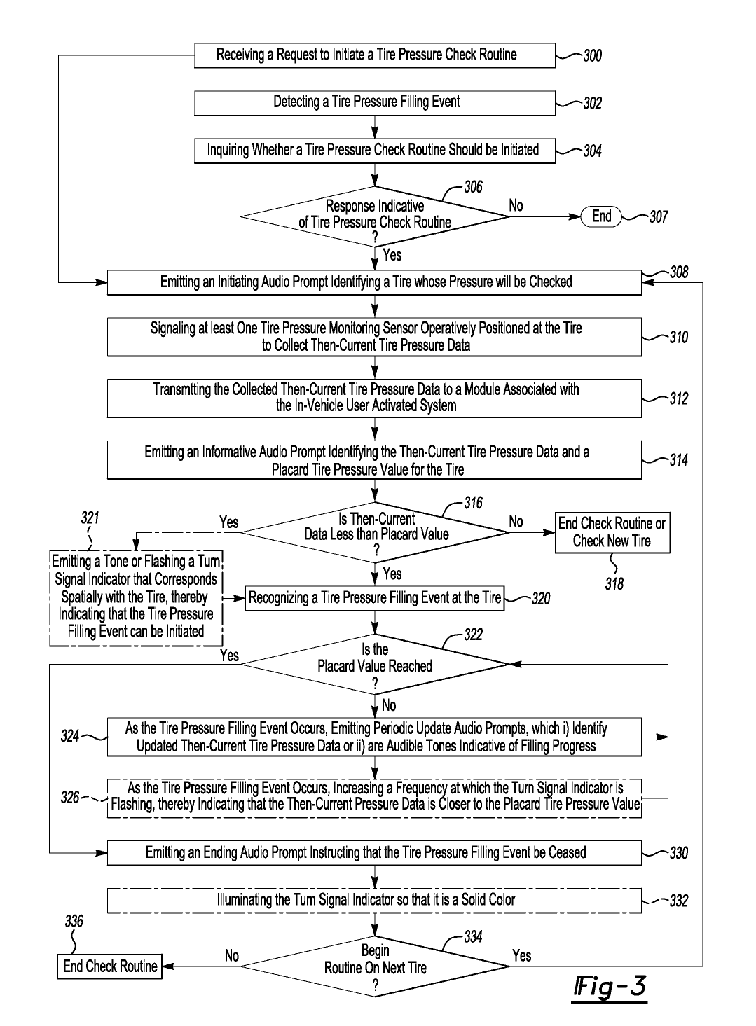

In particular, each of the engines 18 and 20 is capable of communicating with (via signals) a tire pressure check routine engine 28, which includes preset voice prompts and/or audible signals for guiding a user through a tire pressure check routine. More particularly, when a user utilizes the microphone 22, control(s) 24, or display 26 to request the tire pressure check routine, the corresponding engine 18 or 20 transmits a signal to the tire pressure check routine engine 28 instructing the engine 28 to begin the tire pressure check routine (which is discussed further hereinbelow in reference to FIG. 3).

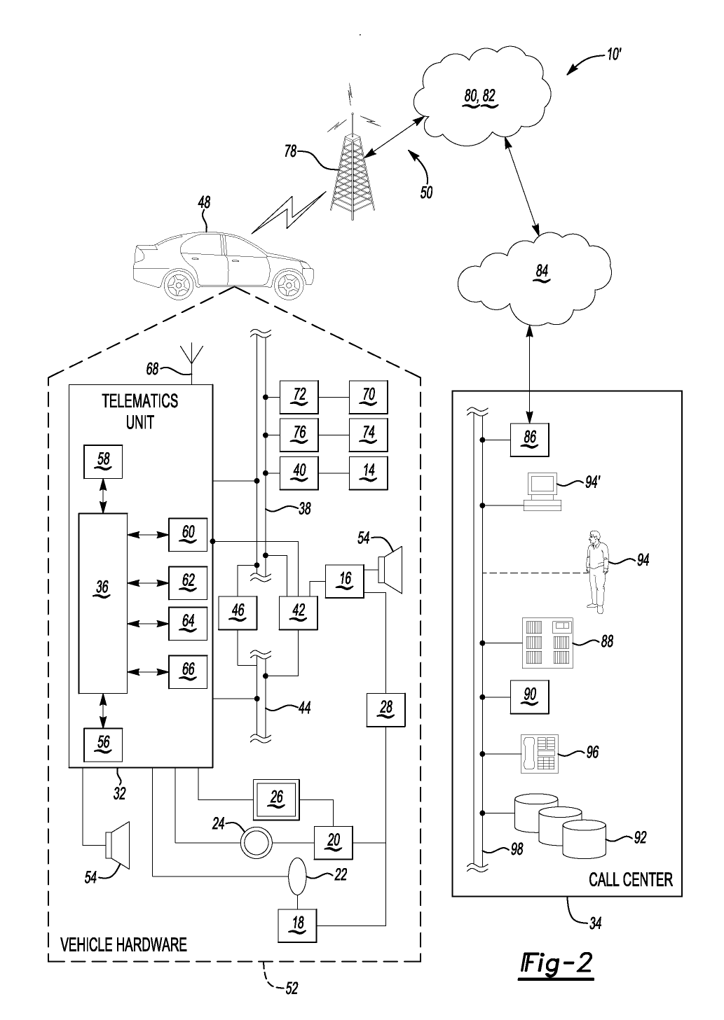

The user activated system 12 also includes a monitoring system 30 for detecting a tire filling event. In the example shown in FIG. 1, the monitoring system 30 is a telematics unit 32. Generally, the telematics unit 32 is an onboard device that provides a variety of services, both individually and through its communication with a call center (shown as reference numeral 34 in FIG. 2). The telematics unit 32 includes an electronic processing device 36 operatively coupled to one or more other electronic devices, which are discussed further in reference to FIG. 2. The telematics unit 32 acts as the monitoring device 30 when it is configured to receive PSI data from a vehicle bus 38 and recognize that a change in air pressure is or has taken place. It is to be understood however, that any vehicle module (e.g., body control module (BCM)) in communication with the vehicle bus 38 may be configured to act as the monitoring system 30.

The vehicle bus 38 is a network connection selected from a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 38 enables the vehicle (48, not shown in FIG. 1) to send and receive signals from the telematics unit 32 to various units of equipment and systems both outside the vehicle and within the vehicle to perform various functions, such as unlocking a door, executing personal comfort settings, and/or the like.

The vehicle bus 38 is in operative communication with various tire sensors 14 that monitor one or more conditions, such as air pressure and/or air temperature within a respective one of the vehicle tires (not shown). The sensors 14 may be in communication with electronic modules (not shown), which transmit signals (e.g., radio frequency signals) indicative of the conditions sensed by the sensors 14 to a receiver 40 in operative communication with the vehicle bus 38. It is to be understood that each of the sensors 14 may be in communication with a single receiver 40. Generally, the receiver 40 acts as a temporary repository for the received signals (indicative of air pressure/temperature data), until such data is pulled from or pushed to the vehicle bus 38, and transmitted to the telematics unit 32 and/or a conversion module 42.

The transmission of data from the receiver 40 to other in-vehicle modules generally includes transmission to at least the telematics unit 32 and the conversion module 42. In some instances, information is transmitted directly to both components (e.g., when the data is broadcast to a number of modules operatively connected to the bus 38). Data is transmitted to the telematics unit 32 when it is acting as a detection module (or monitoring system 30) and so that it can run comparisons between then-current readings and placard values. Data is transmitted to the module 42 for conversion and presentation to a vehicle user. In some instances, the data is transmitted to the telematics unit 32 for comparison with a placard value, and then to the module 42 for conversion and presentation. Data may also be transmitted to the telematics unit 32 for storage and possible transmission to the call center 34. The various aspects will be discussed further herein in reference to FIG. 3.

The conversion module 42 is a system that receives the analog or digital signals from the receiver 40, and renders such signals as sound. Analog signals may be transmitted through an audio bus 44, while digital signals may be transmitted through the vehicle bus 38. In one example, the signals are digital until the audible signals are generated and broadcast into the vehicle from the audio system 16. The types of signals depend, at least in part, upon the source of the signals. The module 42 converts the received signals into voice communications (e.g., a then-current PSI reading) or other audible feedback (e.g., audible tone(s) indicative of a tire pressure level change). The conversion module 42 includes suitable software routines for analyzing the received data and for converting such data to a suitable audio output for delivery to a user via the audio system 16.

The audio system 16 is operatively connected to the vehicle bus 38 and to the audio bus 44 (through the module 42). The audio system 16 provides AM and FM radio, satellite radio, CD, DVD, multimedia and other like functionality independent of an infotainment center (shown as 46 in FIG. 2). Audio system 16 may contain a speaker system, or may utilize other in-vehicle speaker(s) via arbitration on vehicle bus 38 and/or audio bus 44.

Referring now to FIG. 2, another example of the system 10′ is depicted. In this example, all of the components of the system 10 of FIG. 1 are depicted with various other components that may be included in the system 10′. It is to be understood that all of the system 10 components of FIG. 1 are in-vehicle or on-board components of the vehicle 48.

It is to be understood that the overall architecture, setup and operation, as well as many of the individual components of the system 10′ shown in FIG. 2 are generally known in the art. Thus, the following paragraphs provide a brief overview of one example of such a system 10′. It is to be understood, however, that additional components and/or other systems not shown here could employ the method(s) disclosed herein.

The vehicle 48 is a mobile vehicle, such as a motorcycle, car, truck, recreational vehicle (RV), boat, plane, etc. The vehicle 48 may come equipped with suitable hardware and software that enables them to communicate (e.g., transmit and/or receive voice and data communications) over a wireless carrier/communication system 50, or such hardware and software may be added thereto if such equipment is not originally available.

Some of the vehicle hardware 52 is shown generally in FIG. 2, including the telematics unit 32 and other components that are operatively connected to the telematics unit 32. Examples of such other hardware 52 components include the microphone 22, speaker(s) 54, buttons (which also includes knobs, switches, keyboards, controls, and/or the like) 24, and/or a digital display 26. Generally, these hardware 52 components enable a user to communicate with the telematics unit 32 and any other system 10, 10′ components in communication with the telematics unit 32, for example to activate or engage one or more of the vehicle components. In one example, one of the buttons 24 may be an electronic pushbutton used to initiate voice communication with the call center 34 (whether it be a live advisor 94 or an automated call response system 94′). In another example, one of the buttons 24 may be used to initiate emergency services. In still another example, one of the buttons 24 may be used to initiate the tire pressure check routine engine 28.

As discussed in reference to FIG. 1, the telematics unit 32 is an on-board device that provides a variety of services, both individually and through its communication with the call center 34. The telematics unit 32 generally includes electronic processing device 36 operatively coupled to one or more types of electronic memory 56, a cellular chipset/component 58, a wireless modem 60, a navigation unit containing a location detection (e.g., global positioning system (GPS)) chipset/component 62, a real-time clock (RTC) 64, a short-range wireless communication network 66 (e.g., a BLUETOOTH® unit), and/or a dual antenna 68. In one example, the wireless modem 60 includes a computer program and/or set of software routines executing within processing device 36.

It is to be understood that the telematics unit 32 may be implemented without one or more of the above listed components, such as, for example, the short-range wireless communication network 66. It is to be further understood that telematics unit 32 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 62 may include a Global Position System (GPS) receiver, a radio triangulation system, a dead reckoning position system, and/or combinations thereof In particular, a GPS receiver provides accurate time and latitude and longitude coordinates of the vehicle 48 responsive to a GPS broadcast signal received from a GPS satellite constellation (not shown).

The cellular chipset/component 58 may be an analog, digital, dual-mode, dual-band, multi-mode and/or multi-band cellular phone. The cellular chipset-component 58 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be short-range wireless communication technologies, such as BLUETOOTH®, dedicated short-range communications (DSRC), or Wi-Fi. However, these short-range wireless protocols are generally used with the short-range wireless communication network 66 when it is included in the system 10′.

Also associated with electronic processing device 36 is the previously mentioned real time clock (RTC) 64, which provides accurate date and time information to the telematics unit 32 hardware and software components that may require and/or request such date and time information (e.g., to associate air pressure and/or temperature readings with a time and date). In an example, the RTC 64 may provide date and time information periodically, such as, for example, every ten milliseconds.

In addition to the tire air pressure and/or temperature sensors 14, the vehicle 48 may also include crash/collision sensors 70 and/or any other desirable vehicle sensors 74. The crash/collision sensors 70 can detect, for example, the speed at which an impact takes place, the severity of a vehicle collision, such as the angle of impact and the amount of force sustained, or the like. The other sensors 74 include, but are not limited to gyroscopes, accelerometers, magnetometers, emission detection and/or control sensors, and/or the like.

The sensors 70 and 74 are operatively connected to respective interface modules 72 (e.g., a vehicle crash and/or collision detection sensor interface) and 76 (e.g., powertrain control module, climate control module, body control module, and/or the like). Each of the interfaces 72 and 76 includes hardware that receives information from the respective sensors 70 and 74 and transmits such information to the telematics unit 32 via the vehicle bus 38.

As shown in FIG. 2, in addition to the vehicle 48 and its associated components, the system 10′ may also include the previously mentioned wireless carrier/communication system 50 (including, but not limited to, one or more cell towers 78, one or more base stations 80 and/or mobile switching centers (MSCs) 82, one or more land networks 84, one or more service providers (not shown)), and one or more call centers 34. In an example, the wireless carrier/communication system 50 is a two-way radio frequency communication system.

Vehicle communications preferably use radio transmissions to establish a voice channel with wireless carrier system 50 such that both voice and data transmissions may be sent and received over the voice channel. Vehicle communications are enabled via the cellular chipset/component 58 for voice communications and the wireless modem 60 for data transmission. In order to enable successful data transmission over the voice channel, wireless modem 60 applies some type of encoding or modulation to convert the digital data so that it can communicate through a vocoder or speech codec incorporated in the cellular chipset/component 58. It is to be understood that any suitable encoding or modulation technique that provides an acceptable data rate and bit error may be used with the examples disclosed herein. Generally, dual mode antenna 68 services the location detection chipset/component 62 and the cellular chipset/component 58.

The microphone 22 provides the user with a means for inputting verbal or other auditory commands, and can be equipped with an embedded voice processing unit utilizing human/machine interface (HMI) technology known in the art. Conversely, speaker 54 provides verbal output to the vehicle occupants and can be either a stand-alone speaker specifically dedicated for use with the telematics unit 32 or can be part of a vehicle audio system 16. In either event and as previously mentioned, microphone 22 and speaker 54 enable vehicle hardware 52 and call center 34 to communicate with the occupants through audible speech or, in some instances, tones.

Wireless carrier/communication system 50 may be a cellular telephone system or any other suitable wireless system that transmits signals between the vehicle hardware 52 and land network 84. According to an example, wireless carrier/communication system 50 includes the one or more cell towers 78, the base stations 80 and/or mobile switching centers (MSCs) 82, as well as any other networking components required to connect the wireless system 50 with land network 84. It is to be understood that various cell tower/base station/MSC arrangements are possible and could be used with wireless system 50. For example, a base station 80 and a cell tower 78 may be co-located at the same site or they could be remotely located, and a single base station 80 may be coupled to various cell towers 78 or various base stations 80 could be coupled with a single MSC 82. A speech codec or vocoder may also be incorporated in one or more of the base stations 80, but depending on the particular architecture of the wireless network 50, it could be incorporated within a Mobile Switching Center 82 or some other network components as well.

Land network 84 may be a conventional land-based telecommunications network that is connected to one or more landline telephones and connects wireless carrier/communication network 50 to call center 34. For example, land network 84 may include a public switched telephone network (PSTN) and/or an Internet protocol (IP) network. It is to be understood that one or more segments of the land network 84 may be implemented in the form of a standard wired network, a fiber or other optical network, a cable network, other wireless networks such as wireless local networks (WLANs) or networks providing broadband wireless access (BWA), or any combination thereof.

Call center 34 is designed to provide the vehicle hardware 52 with a number of different system back-end functions and, according to the example shown here, generally includes one or more switches 86, servers 88 and software 90 associated therewith, databases 92, live and/or automated advisors 94, 94′, as well as a variety of other telecommunication and computer equipment 96 that is known to those skilled in the art. These various call center components are coupled to one another via a network connection or bus 98, similar to the one (vehicle bus 38) previously described in connection with the system 10 and vehicle hardware 52.

The live advisor 94 may be physically present at the call center 34 or may be located remote from the call center 34 while communicating therethrough via telecommuting.

Switch 86, which may be a private branch exchange (PBX) switch, routes incoming signals so that voice transmissions are usually sent to either the live advisor 94 or an automated response system 94′, and data transmissions are passed on to a modem (not shown) or other piece of equipment for demodulation and further signal processing. The modem preferably includes an encoder, as previously explained, and can be connected to various devices such as the server 88 and/or databases 92. The database 72 may be designed to store subscriber profile records, subscriber behavioral patterns, vehicle data (e.g., tire pressure fill times/dates, tire rotation dates, etc.), or any other pertinent subscriber information.

It is to be appreciated that the call center 34 may be any central or remote facility, manned or unmanned, mobile or fixed, to or from which it is desirable to exchange voice and data communications.

In some instances, the call center 34 is a data center that receives voice or data calls, analyzes the request associated with the voice or data call, and transfers the call to an application specific call center (not shown). It is to be understood that the application specific call center may include all of the components of the call center 34, but is a dedicated facility for addressing specific requests, needs, etc. Examples of such application specific call centers are emergency services call centers, navigation route call centers, in-vehicle function call centers, or the like.

Furthermore, although a service provider (not shown) may be located at the call center 34, the call center 34 is a separate and distinct entity from the service provider. In an example, the service provider is located remote from the call center 34. A service provider provides the user with telephone and/or Internet services. In an example, the service provider is a wireless carrier (such as, for example, Verizon Wireless®, AT&T®, Sprint®, etc.). It is to be understood that the service provider may interact with the call center 24 to provide service(s) to the user.

Referring now to FIG. 3, examples of the tire pressure gauge method (utilizing at least the system 10) are depicted. As used herein, the phrase “tire pressure check routine” (TPCR) refers to a tour, guided by the in-vehicle system 12, which takes a user through the process of checking tire pressure and, if needed, filling their vehicle tires. Generally, the tire pressure check routine is performed during an ignition ON cycle of the telematics unit 32 (by activating the vehicle electronics, but not the engine of the vehicle 48).

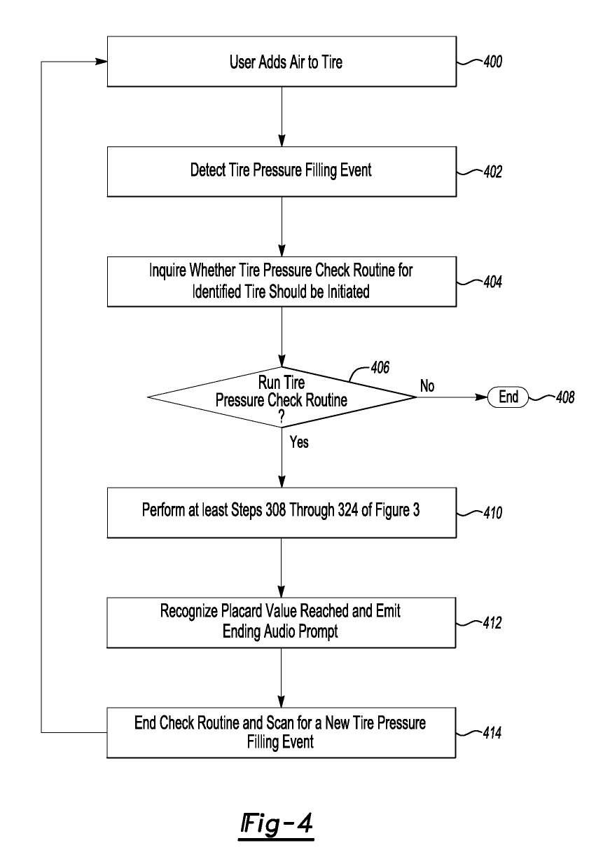

In each of the examples disclosed herein, the tire pressure check routine is initiated by the user. In one example, the user initiates the routine on his/her own accord (see reference numeral 300). In another example, the user is asked if he/she wishes to initiate the routine after a tire pressure filling event is detected (see, e.g., reference numerals 302 through 306, which will be discussed further hereinbelow). In still another example (shown and discussed in reference to FIG. 4), the user is asked if he/she wishes to initiate a routine for a single tire after the tire pressure filling event is detected. In this example, the routine ends after one tire is filled, and begins again only after another filling event is recognized by the system 10. This enables a completely user directed routine, where the system 10 follows the actions of the user.

Referring back to reference numeral 300, one example of the method begins when the user activated system 12 receives a request (e.g., from a vehicle user) to initiate the tire pressure check routine. The user may request the routine via the button 24, a display icon on the display 26, or by speaking a command into the microphone 22. The associated engine 18 or 20 will recognize the command, and in response, will transmit a signal to the tire pressure check routine engine 28 indicating that the TPCR has been requested.

The tire pressure check routine engine 28 initiates the routine by emitting (via the audio system 16) a preset audio prompt (also referred to herein as the initiating audio prompt) that identifies a tire whose pressure will be checked first. For example, when a user requests the TPCR, the default protocol for the TPCR may be to check the driver's side front tire first or to check the tire with the lowest PSI first. In this example, the engine 28 will emit, via the audio system 16, a preset voice prompt stating, for example, “Checking Driver Side Front Tire.” It is to be understood that the default protocol may be such that any of the tires is first in the order for being checked. Furthermore, the default protocol may be revised to change the order of the tires. This may be useful, for example, if a user is keeping a close watch on the air in a particular tire. The user may request that the call center 34 update the protocol for the TPCR such that the tire likely of most interest is checked first.

The tire pressure check routine engine 28 is operatively connected to the vehicle bus 38 so that it can transmit a request signal to the vehicle bus 38. This request signal commands the vehicle bus 38 to pull a then-current tire pressure reading from sensor(s) 14 associated with the identified tire. The vehicle bus 38 may have to transmit another signal prompting the sensor(s) 14 to take a reading (see reference numeral 310), unless such data is being consistently reported (e.g., every second) in which the vehicle bus 38 may transmit the most recently reported value. It is to be understood that the engine 28 may be directly connected to the vehicle bus 38, or such communication may take place through the telematics unit 32.

During this step, the vehicle bus 38 also requests the placard value for the particular tire. In one example, the placard value is stored in the telematics unit memory 56. The value may be initially stored in the telematics unit 32 at the end of the vehicle manufacturing line. The value may be updated by a user, for example, via a telematics web service after the tires have been rotated or replaced. The user may also update the value using a voice command or other in-vehicle control. In one example, the user can set and store the value at any desirable time. In another example, the system 10 is configured to require the user to enter the placard value (e.g., via a voice command or other in-vehicle control) as the TPCR is started (e.g., at the very beginning or before each tire is checked). The value may also be updated by the call center 34, for example, via the wireless communication system 50 after various conditions have been recorded at the vehicle 48 at a point in time or over time. For example, if a user updates his/her garage address from a sunny climate to a cold climate, the placard value of the tires may need to be adjusted due to the change in temperature. The call center 34 can recognize the change in the user's profile, request the most recent information regarding the tire maintenance, determine a new placard value, and load such placard value(s) onto the telematics unit 32. It is to be understood that any updated values will replace the previous values.

In another example, the placard value is dynamically generated (i.e., at the request of the vehicle bus 38) at the vehicle 48 or at the call center 34. The telematics unit 32 or the call center 34 will receive the then-current tire pressure and the then-current outside temperature (which are taken by one or more sensors 14) from the vehicle bus 38 (or audio bus 44 if in the form of an analog signal). When generated on-board, the telematics unit 32 utilizes an algorithm to generate the placard value from the then-current tire pressure, the then-current outside temperature, and in some instances, the then-current location of the vehicle 48. When generated off-board, the vehicle bus 38 transmits the then-current information to the call center 34 which has the advantage of utilizing the then-current data in conjunction with previously stored data (e.g., vehicle driving history, location history, maintenance history, etc.) to generate the placard value. Whether the placard value is pulled from the telematics unit memory 56 or is dynamically generated at the telematics unit 32 or at the call center 34, the placard value is transmitted to the module 42.

Once the then-current air pressure reading is obtained from the sensor(s) 14 or the receiver 40, the vehicle bus 38 transmits the signal to the module 42, as shown at reference numeral 312. The module 42 includes a software routine that can analyze and interpret the signals indicative of the then-current air pressure and the placard value, and then convert the signals indicative of the air pressure and the placard value to an informative audio prompt. This particular audio prompt is transmitted over the audio system 16, thereby audibly identifying the then-current air pressure reading and the placard value for the user (see reference numeral 314). For example, the informative audio prompt may say something like, “driver side front tire is currently 32 PSI and placard value is 35 PSI.”

The then-current air pressure reading is also transmitted to the telematics unit 32, which is configured to compare the then-current air pressure with the placard value, and determine whether the then-current data is less than the placard value, as shown at reference numeral 316. If the then-current air pressure is not less than the placard value, then the telematics unit 32 will instruct the module 42 to emit the information audio prompt with the two pressure values, and then will ask the user if he/she wishes to end the TPCR or continue the TPCR with the next tire (see reference numeral 318).

It is to be understood that the then-current air pressure readings may be taken for each tire simultaneously. In this instance, the telematics unit 32 receives all of the data and runs the comparison for each tire. If the tire pressure of each tire is at or above the placard value, the system 10 will indicate to the user that the tires have suitable pressure and the TPCR is not necessary. In this particular instance, the TPCR would end.

If, however, the then-current data is less than the placard value, then a few different scenarios are possible. The system 10 can do nothing and wait for recognition of a tire pressure filling event, as shown at reference numeral 320. In this instance, the user is aware that the tire air pressure is low and that air should be added to the tire by virtue of the informative audio prompt. As such, the monitoring system 30 (e.g., telematics unit 32 or some other in-vehicle module configured to detect a change in pressure at the respective tires) scans incoming data signals from the vehicle bus 38 looking for a change in the air pressure at the tire.

In some instances, prior to the monitoring system 30 recognizing the tire pressure filing event, the module 42 may be configured to emit a tone or prompt via the audio system 16 indicating to the user that filling of the tire may begin, as shown at reference numeral 321. The prompt may be something like, “begin filling driver side front tire” or simply “begin filling.” The tone may be a default tone or a user selected tone (e.g., via a telematics service web page or a display screen in the vehicle 48) that indicates to the user that filling may begin. Such prompts and/or tones would be emitted after the module 42 recognizes that the then-current data is less than the placard value. In other instances, prior to the monitoring system 30 recognizing the tire pressure filing event, the vehicle bus 38 may send a signal to the turn signal (shown as reference numeral 15 in FIG. 1) located on the same side as the tire to be filled to begin flashing at a predetermined rate. The flashing of the turn signal 15 may act as an indicator to the user that the filling of the tire may begin. In still other instances, both an audible prompt/tone and the flashing turn signal 15 may be used to indicate to the user that the tire may be filled.

Once the user begins filling the tire and the monitoring system 30 recognizes a change in the air pressure of the tire, the vehicle bus 38 will be triggered to periodically pull pressure values from the sensor(s) 14 as the filling event occurs. The periodic values may be retrieved at predetermined intervals during the filling event. For example, the vehicle bus 38 may request an updated pressure reading every 500 milliseconds, every second, every 2 seconds, or at any desirable preset time period. The monitoring system 30 continues to monitor the tire pressure filling event so that the vehicle bus 38 knows to continue to retrieve then-current data according to the preset intervals. The intermittent or periodic pressure values that are received at the vehicle bus 38 will be transmitted to the telematics unit 32. The telematics unit 32 is configured to again compare the then-current tire pressure value to the placard value (previously received) to determine if the pressure in the tire has reached the placard value (see reference numeral 322). Since multiple updated values may be transmitted during the filling event, it is to be understood that the comparison may be performed multiple times for each value received.

If, after a respective comparison is complete, the placard value is not reached, the module 42 will convert the then-current value into a voice communication which indicates to the user the actual tire pressure value at that time, or into a tone or series of tones that are indicative of the filling progress, as shown at reference numeral 324. For example, if the placard value is 35 PSI and as filling occurs a value of 34 PSI is received, the module 42 may transmit an audio output of “34 PSI” or “current tire pressure is 34 PSI, keep filling” or “placard not reached, keep filling” or the like. The tone utilized for the periodic updates may be a continuous tone or beep that increases in volume and/or frequency as the then-current tire pressure value gets closer to the placard value. For example, a beep may be used that begins slowly, increases in speed as filling progresses, and ultimately is a solid tone when the placard value is reached. Alternatively, a different tone may be used for each of the periodic updates, thus signifying to the user that the tire pressure is closer to the placard value.

It is to be understood that as the filling event continues, the periodic updates may continuously (i.e., at each interval when a value is retrieved and compared to the placard value) be transmitted to the user via the audio system 16. For example, after one of the periodic updates is emitted, the module 42 may receive another tire pressure value from the vehicle bus 38 at the next predetermined interval. The telematics unit 32 will perform the comparison with the placard value, and if the placard value is again not reached, will instruct the module 42 to emit another periodic update with the more recent tire pressure value. This loop is shown between reference numerals 322 and 324, and will continue until the placard value is reached.

During the tire pressure filling event, the system 10 may also be configured so that the turn signal 15 indicator is utilized to update the user of the tire filling progress, as shown at reference numeral 326. In this example, as the vehicle bus 38 receives increasing tire pressure values from the signals(s) 14 and receiver 40, it may transmit a signal to the turn signal 15 located on the same side as the tire being filled commanding it to continue flashing at a predetermined rate. As the tire pressure increases, the rate at which the flashing occurs may increase or decrease, depending upon how the indicators are being used. In one example, the flashing is increased as the tire pressure increases; and when the placard value is reached, the turn signal 15 will be illuminated without flashing (see, e.g., reference numeral 332). In another example, the flashing is decreased as the tire pressure increases, indicating that the filling event is nearing an end. In this example, when the placard value is reached, the turn signal 15 will be turned off.

When the comparison indicates that the received then-current tire pressure value is the same or greater than the placard value, the module 42 will be instructed to transmit an ending audio prompt or tone via the audio system 16 which instructs the user to cease the tire pressure filling event, as shown at reference numeral 330. For example, if the placard value is 35 PSI and the comparison indicates that the then-current tire pressure is 35 PSI, the module 42 may transmit an audio output of “35 PSI has been reached, stop filling” or “placard value obtained, stop filling” or “stop filling” or the like. In one example, the tone utilized for the ending audio prompt may be a high pitched tone or an intermittent buzzer that continues until a change in air pressure is not recognized or the user manually instructs the system 10. As mentioned above, the turn signal 15 may also be used in conjunction with the ending audio prompt to indicate to the user that the tire is full (see reference numeral 332).

Once the TPCR is complete for the first tire, the module 42 is configured to prompt the user about whether he/she wishes to end the TPCR or continue the TPCR with the next tire (see reference numeral 334). If the user indicates that he/she wishes to end the TPCR, the method will cease (see reference numeral 336). However, if the user indicates (e.g., verbally or via an in-vehicle button 24 or display 26) that he/she wishes to continue the TPCR, the method will return to reference numeral 308 and repeat the process for the second tire in the protocol of the routine. This will continue until all the tires have been checked and, if needed, filled, or until the user stops the routine. In this particular example, the then-current pressure is checked for each tire separately, and if the tire does not need more air, the system 10 will move on to the next tire.

In another example, the order of routine may be determined at the outset of the method by the then-current PSI values of the tires. For example, the system 10 may be configured to check all of the tires at the outset of the TPCR, and then prompt the user to begin a filling event at the first tire that is low. As such, during one TPCR, the then-current pressure of all of the tires may be checked at the outset, and then the system 10 will guide the user to fill those tires in need of more air one at a time. For example, if two of the four tires are identified as having low air pressure, the routine will guide the user to the first of the low tires for a filling event, and then upon completion of that filling event, will guide the user to the second of the low tire for a filling event. After completion of both of these filling events, the TPCR will end.

It is to be understood that the user may stop the routine at any time throughout the method by commanding the system 10 to stop (e.g., by verbally instructing the system 10 or by inputting the command via a button 24 or the display 26). Additionally, the TPCR may automatically stop or end if, after being initiated, there is no change in PSI detected on any tire for a predetermined period of time (i.e., the TPCR times out).

Referring back to reference numerals 302 through 308 of FIG. 3, another example of the method begins when the monitoring system 30 recognizes a tire pressure filling event. In this example, the user does not initiate the TPCR, but rather begins filling one of the tires. The monitoring system 30 will detect the change in pressure (as shown at reference numeral 302) and the module 42 will inquire as to whether the user would like to initiate the tire pressure check routine (as shown at reference numeral 304). This inquiry is accomplished by emitting a preset voice communication that asks the user, for example, “do you want to initiate the tire pressure check routine?” or “do you want to utilize the virtual tire gauge?” or the like.

The user can respond verbally (e.g., by speaking the response into the microphone 22) or physically (e.g., via the button (or other control) 24 or a display icon on the display 26). The associated engine 18 or 20 will recognize the response, and in response, will transmit a signal to the tire pressure check routine engine 28 indicating that the TPCR has been requested or not requested. When the user does not wish to initiate the TPCR, the method will end (as shown at reference numeral 307). However, when the user does wish to initiate the TPCR, the method will continue at reference numeral 308 and the steps will be accomplished as previously described.

Another example of the method is depicted in FIG. 4. In this example, the method begins when the user adds air to one of the tires (see reference numeral 400) and the monitoring system 30 recognizes the tire pressure filling event (see reference numeral 402). In this example, the user does not initiate the TPCR, but rather begins filling one of the tires. The monitoring system 30 will detect the change in pressure, and the module 42 will inquire as to whether the user would like to initiate the tire pressure check routine for the identified tire (as shown at reference numeral 404). This inquiry is accomplished by emitting a preset voice communication that asks the user, for example, “do you want to initiate the tire pressure check routine?” or “do you want to utilize the virtual tire gauge?” or the like.

The user can respond verbally (e.g., by speaking the response into the microphone 22) or physically (e.g., via the button (or other control) 24, or a display icon on the display 26, or another device operative connected to the vehicle 48). The associated engine 18 or 20 will recognize the response, and in response, will transmit a signal to the tire pressure check routine engine 28 indicating that the TPCR has been requested or not requested for the particular tire being filled. When the user does not wish to initiate the TPCR, the method will end (as shown at reference numerals 406 and 408). However, when the user does wish to initiate the TPCR for the tire, the method will continue at reference numeral 410, and at least steps 308 through 324 will be accomplished as previously described for the tire.

In this example and as shown in reference numeral 412, when the tire is filled at or above the placard value, the telematics unit 32 will recognize that the placard value has been reached, and the module 42 will emit the ending audio prompt. Rather than asking whether the user wishes to continue the TPCR, the system 10 will simply wait for the user to begin another filling event, as shown at reference numeral 414. The telematics unit 32 may be configured to scan the vehicle bus 38 output to determine if another filling event is initiated. As such, in this embodiment of the method, the TPCR is initiated potentially multiple times based upon the user's actions (i.e., adding air to the tire(s)) as opposed to the process being initiated and guiding the user through the filling of each tire.

While the examples shown and discussed in reference to FIGS. 3 and 4 utilize the in-vehicle speaker(s) 54 to emit the audio prompts (in the form of voice communications or tones), it is to be understood that the audio system 16 may transmit the audio prompts to a wireless communication device (not shown) that is in communication with (i.e., has been linked to) the telematics unit 32. For example, a user may utilize a short-range wireless communication device by linking such device to the telematics unit 32 of the in-vehicle system 10. For example, the user may receive the audible prompts/tones via an earpiece that utilizes BLUETOOTH® communication, and thus the user does not have to have the in-vehicle volume up to a level that can be heard at each tire. In another example, the wireless device may have a specific application installed thereon for initiating and receiving prompts of the TPCR. In such instances, the prompts may also be visual.

In some instances, the user may select the tone characteristics (i.e., sound used, volume level, frequency, etc.) or the audio voice prompts/communications that should be used throughout the TPCR. Preset tones and prompts may be saved in the module 42, and the user may select from the list of preset prompts/tone using the in-vehicle display 26 or a telematics service web page.

While not shown in the figures, it is to be understood that the telematics unit 32 may transmit any data associated with the tire pressure check routine to the call center 34 over a voice channel or as packet data. Such data includes, but is not limited to, each recorded then-current tire pressure, the initial and final tire pressure values, the placard value, a time and/or date stamp of the filling event, an amount of air added to each of the tires, the tires checked, the tires filled, etc. The uploading of the recording takes place during a vehicle data upload event. The vehicle data upload event takes place at some predetermined interval (e.g., data is uploaded to the call center 34 every day), or in response to some trigger (e.g., when the tire pressure check routine is complete), or when requested (i.e., on demand from the telematics unit 32 or the call center 34). The telematics unit 32 may include a vehicle data upload (VDU) system (not shown), which is configured to receive raw vehicle data from the bus 38, packetize the data, and upload the packetized raw data to the call center 34 (or other external entity). The VDU is operatively connected to the processor 36 of the telematics unit 32, and thus is in communication with the call center 34 via the bus 38 and the wireless communication system 50. The VDU may be the telematics unit's central data system that can include a modem, a processor, and an on-board database. The database can be implemented using a separate network attached storage (NAS) device or be located elsewhere, such as in memory 56, as desired. The VDU system has an application program that handles all of the vehicle data upload processing, including communication with the call center 34 and the setting and processing of triggers.

Once the call center 34 has the data, it may be organized and stored in the associated subscriber's profile in the database 72. When the transmission of the data takes place, the vehicle 48 making such transmission is identified at the call center 34 via one or more identifiers associated with the telematics unit 32 or vehicle 48.

The call center 34 may use the data to keep track of the tire maintenance for the vehicle 48. For example, the call center 34 may maintain the air pressure data (e.g., frequency of air fill ups recorded via the methods disclosed herein) with other data, such as, tire rotations, tire replacements, etc. input via the user and/or dealership performing such maintenance. Such data may be used for generating re-sale reports, for transmitting periodic reports to the user, for alerting the user of patterns in tire inflation (e.g., the call center 34 notices that the user fills up the passenger side rear tire more often than the other tires), for prompting a user when maintenance comes due, or for any other desirable use.

While several examples have been described in detail, it will be apparent to those skilled in the art that the disclosed examples may be modified. Therefore, the foregoing description is to be considered exemplary rather than limiting.

1. An in-vehicle tire gauge system, comprising:
a user activated system operatively positioned in a vehicle, the user activated system including:
at least one of preset voice prompts or audible tones for guiding a tire pressure check routine;
a monitoring system for detecting a tire filling event;
a module for converting tire pressure data into audible feedback;
at least one tire pressure monitoring sensor operatively positioned at each tire of the vehicle and configured to collect the tire pressure data and transmit such data to the module; and
an audio system in operative communication with the user activated system and configured to output, via in-vehicle speakers associated with the audio system, the at least one of preset voice prompts or audible tones, the audible feedback, or combinations thereof.

2. The in-vehicle tire gauge system as defined in claim 1, further comprising:
a receiver operatively connected to the at least one tire pressure monitoring sensor, and configured to receive the tire pressure data from the at least one tire pressure monitoring sensor; and
a vehicle bus operatively connected to the receiver and the module, and configured to receive the tire pressure data from the receiver and transmit the tire pressure data to the module.

3. The in-vehicle tire gauge system as defined in claim 2, further comprising a telematics unit in operative communication with the vehicle bus, and configured to receive the tire pressure data from the vehicle bus.

4. The in-vehicle tire gauge system as defined in claim 3, further comprising a telematics service center in selective communication with the telematics unit, and configured to receive the tire pressure data from the telematics unit.

5. The in-vehicle tire gauge system as defined in claim 1, further comprising an in-vehicle button or an in-vehicle display icon configured to initiate the tire pressure check routine.

6. The in-vehicle tire gauge system as defined in claim 1, further comprising a turn signal indicator configured to identify at least one of i) a tire associated with the tire filling event, ii) a start time for the tire filling event, iii) an end time for the tire filling event, or iv) combinations of i, ii, and iii.

7. A tire pressure gauge method, comprising:
emitting, via an in-vehicle user activated system and an in-vehicle audio system, an initiating audio prompt identifying a tire whose pressure will be checked;
signaling at least one tire pressure monitoring sensor operatively positioned at the tire to collect then-current tire pressure data;
transmitting the collected then-current tire pressure data to a module associated with the in-vehicle user activated system;
emitting, via the in-vehicle user activated system and the in-vehicle audio system, an informative audio prompt identifying the then-current tire pressure data and a placard tire pressure value for the tire;
recognizing a tire pressure filling event at the tire;
as the tire pressure filling event occurs, emitting, via the in-vehicle user activated system and the in-vehicle audio system, periodic update audio prompts, each of which i) identifies updated then-current tire pressure data or ii) is an audible tone indicative of filling progress; and
when the placard tire pressure value is reached, emitting, via the in-vehicle user activated system and the in-vehicle audio system, an ending audio prompt instructing that the tire pressure filling event be ceased.

8. The tire pressure gauge method as defined in claim 7 wherein prior to emitting the initiating audio prompt, the method further comprises receiving an input to initiate a tire pressure check routine via the in-vehicle audio system, an in-vehicle button or an in-vehicle display icon.

9. The tire pressure gauge method as defined in claim 7, further comprising:
emitting, via the in-vehicle user activated system and the in-vehicle audio system, a second initiating audio prompt identifying a second tire whose pressure will be checked;
signaling at least one tire pressure monitoring sensor operatively positioned at the second tire to collect then-current second tire pressure data;
transmitting the collected then-current second tire pressure data to the module associated with the in-vehicle user activated system;
emitting, via the in-vehicle user activated system and the in-vehicle audio system, a second informative audio prompt identifying the collected then-current second tire pressure data and a placard tire pressure value for the second tire;
recognizing a tire pressure filling event at the second tire;
as the second tire pressure filling event occurs, emitting, via the in-vehicle user activated system and the in-vehicle audio system, periodic update audio prompts, each of which i) identifies updated then-current second tire pressure data or ii) is an audible tone indicative of filling progress; and
when the placard tire pressure value is reached, emitting, via the in-vehicle user activated system and the in-vehicle audio system, an ending audio prompt instructing that the second tire pressure filling event be ceased.

10. The tire pressure gauge method as defined in claim 9, further comprising repeating the steps for at least a third and a fourth tire.

11. The tire pressure gauge method as defined in claim 7 wherein prior to emitting the informative audio prompt, the method further comprises:
collecting a then-current outside temperature; and
using the then-current tire pressure data and the then-current outside temperature to determine the placard tire pressure value for the tire.

12. The tire pressure gauge method as defined in claim 7, further comprising:
transmitting data related to the tire pressure filling event to a telematics unit in operative communication with the in-vehicle user activated system and the in-vehicle audio system, the data related to the tire pressure filling event selected from the then-current tire pressure data, the placard tire pressure value, a timestamp of the tire pressure filling event, a datestamp of the tire pressure filling event, an amount of pressure change applied to the tire, a then-current outside temperature, and combinations thereof; and
transmitting the data related to the tire pressure filling event to a telematics service center in selective communication with the telematics unit.

13. The tire pressure gauge method as defined in claim 12, further comprising generating a tire pressure history report based upon the data received at the telematics service center.

14. The tire pressure gauge method as defined in claim 7, further comprising:
flashing a turn signal indicator that corresponds spatially with the tire, thereby indicating that the tire pressure filling event can be initiated;
as the tire pressure filling event occurs, increasing a frequency at which the turn signal indicator is flashing, thereby indicating that the then-current pressure data is closer to the placard tire pressure value; and
when the placard tire pressure value is reached, illuminating the turn signal indicator so that it is a solid color.

15. The tire pressure gauge method as defined in claim 7, further comprising:
simultaneously with the signaling of the at least one tire pressure monitoring sensor, signaling each other tire pressure monitoring sensor operatively positioned at each other tire to collect then-current tire pressure data from each other tire in addition to the tire;
identifying a placard value for each other tire and the tire; and
from the data and the placard values, identifying which of the tires has a low air pressure.

16. A tire pressure gauge method, comprising:
detecting a tire pressure filling event via an in-vehicle component in operative communication with a vehicle bus that receives PSI information from at least one tire pressure monitoring sensor; and
in response to the detecting, inquiring, via a user activated system in operative communication with the an in-vehicle component, whether a tire pressure check routine should be initiated.

17. The tire pressure gauge method as defined in claim 16, further comprising:
detecting, via the user activated system, an input indicative of initiating the tire pressure check routine;
identifying, via the in-vehicle component, a tire associated with the detected tire pressure filling event;
receiving periodic readings of then-current tire pressure data for the tire at the in-vehicle component; and
emitting, during the tire pressure filling event and via the in-vehicle user activated system and an in-vehicle audio system, periodic update audio prompts relaying the periodic readings of the then-current tire pressure data of the identified tire or audible tones indicative of filling progress.

18. The tire pressure gauge method as defined in claim 17, further comprising:
emitting, via the in-vehicle user activated system and the in-vehicle audio system, an informative audio prompt identifying a placard tire pressure value for the identified tire; and
when the placard tire pressure value is reached during the tire pressure filling event, emitting, via the in-vehicle user activated system and the in-vehicle audio system, an ending audio prompt instructing that the tire pressure filling event be ceased.

19. The tire pressure gauge method as defined in claim 18 wherein prior to emitting the informative audio prompt, the method further comprises:
collecting a then-current outside temperature; and
using the then-current tire pressure data and the then-current outside temperature to determine the placard tire pressure value for the identified tire.

20. The tire pressure gauge method as defined in claim 18 wherein after the ending audio prompt is emitted, the method further comprises:
inquiring, via the user activated system, whether the tire pressure check routine should be continued;
detecting, via the user activated system, an input indicative of continuing the tire pressure check routine;
emitting, via the in-vehicle user activated system and an in-vehicle audio system, an instruction prompt identifying an other tire whose pressure will be checked;
signaling at least one tire pressure monitoring sensor operatively positioned at the other tire to collect then-current other tire pressure data;
transmitting the collected then-current other tire pressure data to the module;
emitting, via the in-vehicle user activated system and the in-vehicle audio system, an other informative audio prompt identifying the then-current other tire pressure data and a placard tire pressure value for the other tire;
recognizing a tire pressure filling event at the other tire;
as the other tire pressure filling event occurs, emitting, via the in-vehicle user activated system and the in-vehicle audio system, periodic update audio prompts, each of which i) identifies updated then-current other tire pressure data or ii) is an audible tone indicative of filling progress; and
when the placard tire pressure value is reached in the other tire, emitting, via the in-vehicle user activated system and the in-vehicle audio system, an other ending audio prompt instructing that the other tire pressure filling event be ceased.

21. The tire pressure gauge method as defined in claim 17, further comprising:
transmitting data related to the tire pressure filling event to a telematics unit in operative communication with the in-vehicle user activated system and the in-vehicle audio system, the data related to the tire pressure filling event being selected from the then-current tire pressure data, the placard tire pressure value, a timestamp of the tire pressure filling event, a datestamp of the tire pressure filling event, an amount of pressure change applied to the tire, and combinations thereof; and
transmitting the data related to the tire pressure filling event to a telematics service center in selective communication with the telematics unit.

22. The method as defined in claim 16, further comprising:
running a the tire pressure check routine for a tire associated with the tire pressure check routine; and
upon filling the tire, ending the tire pressure check routine until an other tire pressure filling event is detected via the in-vehicle component.
